(19) United States
(12) Patent Application Publication
(10) Pub. No.: US 2026/0366545 A1
(43) Pub. Date: Nov. 19, 2026

(54) GRATING CLAMP ASSEMBLY

(71) Applicants: Graham Clarke, Nanoose Bay (CA); Ryan Hodgson, Victoria (CA)

(72) Inventors: Graham Clarke, Nanoose Bay (CA); Ryan Hodgson, Victoria (CA)

(21) Appl. No.: 19/674,558

(22) Filed: May 12, 2026

Related U.S. Application Data
(60) Provisional application No. 63/806,462, filed on May 15, 2025.

(51) Int. Cl. F16B 2/06

(52) U.S. Cl. CPC F16B 2/065; F16B 2200/20

(57) ABSTRACT

Disclosed examples relate to a grating clamp assembly. In some examples, the grating clamp assembly includes a gripping structure, comprising an elongated stem and a cleat member; and a securing bracket, comprising at least two flange members, each flange member having a securing slot hole, wherein in an assembled state, the securing bracket is movably coupled over the elongated stem through one of the securing slot holes.

### CROSS-REFERENCE TO RELATED APPLICATION(S)

This application claims priority to, and the benefit of, U.S. Provisional Patent Application No. 63/806,462 filed on May 15, 2025, the entire contents of which are incorporated herein by reference.

### FIELD

Various examples are described herein that generally relate to grating panels used in construction applications, and in particular, to a grating clamp assembly. The grating clamp assembly may be used for securing structures (e.g., ladders) to grating panels.

### BACKGROUND

Industrial and commercial facilities often utilize grating panels for flooring, walkways, and platforms, providing strength, ventilation, and drainage benefits. It is often necessary to secure additional structures, such as ladders, railings, or equipment, to the grating using grating clamps.

### SUMMARY

In at least one broad aspect, there is provided a grating clamp assembly comprising: a gripping structure, comprising an elongated stem and a cleat member; and a securing bracket, comprising at least two flange members, each flange member having a securing slot hole, wherein in an assembled state, the securing bracket is movably coupled over the elongated stem through one of the securing slot holes.

In some examples, the elongated stem further comprises a limiting portion, and in the assembled state, the securing bracket is coupled between the cleat member and the limiting portion.

In some examples, the clamp assembly further comprises a fastener, and in the assembled state, the fastener is coupled to the elongated stem, between the securing bracket and limiting portion.

In some examples, the cleat member includes one or more load bar engagement portions.

In some examples, at least one of the engagement portions includes a distal protrusion to form a hook-like design.

In another broad aspect, there is provided a method of using the grating clamp assembly comprising: inserting the gripping structure through a load bar spacing, in a grating panel, until the cleat member is disposed on the other side of the grating panel; rotating the gripping structure until the engagement portions, of the cleat member, are aligned under one or more load bars; and engaging the securing bracket over the load bars to couple the clamp assembly.

In some examples, the method initially comprises, rotating the gripping structure such as to allow it to pass through the load bar spacing.

In some examples, the method further comprises, securing the bracket using the fastener.

In some examples, the method further comprises, coupling an external structure to the securing bracket via the other securing hole.

In some examples, the external structure is a ladder, railing, or other equipment.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an image of a grating clamp assembly coupled to a grating panel.

FIG. 2A is an image showing a side perspective view of a grating clamp assembly.

FIG. 2B is a side elevation view of the grating clamp assembly.

FIG. 3A is a side perspective view of an example gripping structure, forming part of the grating clamp assembly.

FIG. 3B is a front elevation view of the example gripping structure.

FIG. 4 is a perspective view of a securing bracket, also forming part of the grating clamp assembly.

FIGS. 5A-5C illustrate a method for coupling a grating clamp assembly to a grating panel, including illustrating perspective views of the grating clamp assembly in (i) the insertable state (FIG. 5A), (ii) the inserted uncoupled state (FIG. 5B), and (iii) the coupled state (FIG. 5C).

FIG. 5D is a front elevation view of the grating clamp assembly in FIG. 5C.

Further aspects and features of the example embodiments described herein will appear from the following description taken together with the accompanying drawings.

### DETAILED DESCRIPTION

Disclosed examples relate to a grating clamp assembly for securing structures (e.g., ladders) to grating panels.

### I. General Overview

As noted above, it is often necessary to secure structures—such as ladders, railings, or equipment—to grating panels. This is typically accomplished using a grating clamp. Conventional grating clamps, however, present challenges in respect of installation, maintenance, and safety.

To this end, a significant issue with existing grating clamp designs is that, to install these clamps, it is necessary to access the underside of the grating panel. This is because bolts and nuts must be fastened underneath the panel, such as to properly secure the clamp to the panel. This necessitates initially removing the grating panel, coupling the clamp to the panel, and then reinstalling the panel onto the grating platform.

One recurring problem is that once panels are removed to secure clamps, personnel installing the clamps forget to then reinstall the panels back onto the grating platform. If the panel forms part of a walkway, the missing panel results in a gap in the walkway that poses serious risks for workers (or other individuals) walking over the walkway platform. In many cases, workers have unknowingly walked over these platform gaps, and sometimes fallen from elevated heights.

Another important drawback to existing clamp designs is, as indicated previously, they rely on fasteners securable from underneath the grating panel. These fasteners can be dropped or dislodged during or after panel installation. In addition to being difficult to retrieve, the fasteners may also fall onto personnel or equipment passing underneath the platform, thereby causing further safety risks and equipment damage.

In view of the foregoing, there is a need for an improved grating clamp that simplifies installation, enhances safety, and eliminates risks associated with removing to install the clamp.

### II. Grating Clamp Assembly

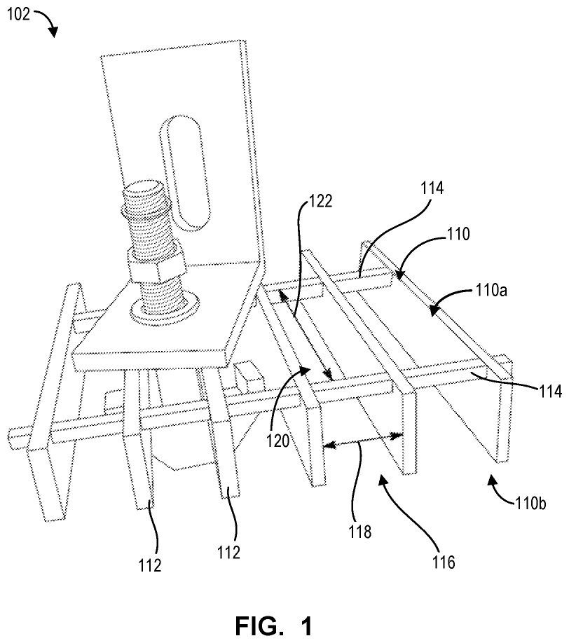

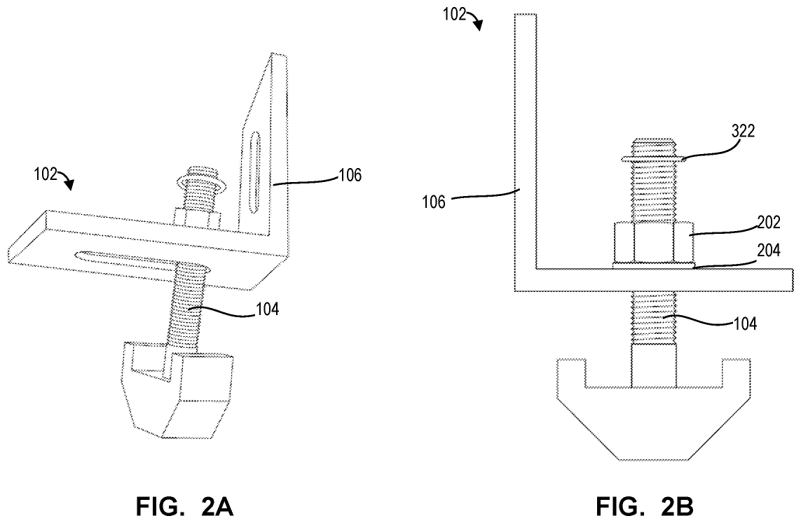

FIGS. 1-2 exemplify a grating clamp assembly 102 in accordance with disclosed examples. FIG. 1 shows the grating clamp assembly 102 coupled to a grating panel 110, while FIGS. 2A-2B exemplify the grating clamp assembly 102 in isolation, and in an assembled state.

As best shown in FIG. 1, a conventional grating panel 110 includes one or more load bars 112 intersecting one or more cross bars 114. A load bar spacing 116 is defined between adjacent load bars 112, and extends by a spacing width 118 (also called a load bar pitch). A cross bar spacing 120 is also defined between adjacent cross bars 114 and extends by a spacing width 122 (also called a crossbar pitch).

Grating panel 110 may, itself, span between a first panel side 110a and a second panel side 110b. Cross bars 114 are generally positioned proximal the first panel side 110a.

For ease of description, the first panel side 110a is also referred to herein as the upper side 110a. Further, the second panel side 110b is also referred to as the lower side 110b. It is understood, however, that the grating panel 110 is not limited to any one particular orientation. More generally, use of positional words (e.g., upper or lower) herein throughout is also non-limiting.

As exemplified in FIG. 2A, the clamp assembly 102 generally includes: (i) a gripping structure 104, couplable to (ii) a securing bracket 106.

In use, the clamp assembly 102 is designed to extend through the grating panel 110 between the upper and lower sides 110a, 110b. In this position, the securing bracket 106 and a portion of the gripping structure 104, of the clamp assembly 102, are located on either side of the load bars 112.

As in FIG. 2B, a fastener 202 (e.g., a nut) may be used to ensure the securing bracket 106 is positionally held in place, over the load bars 112. Optionally, a washer 204 is also included to prevent loosening of the fastener 202.

Once the clamp assembly 102 is secured to the grating panel 110 (FIG. 1), an external structure may be coupled to the securing bracket 106. This allows the clamp assembly 102 to secure the external structure to the grating panel 110.

A more detailed discussion of the gripping structure 104 and securing bracket 106 is now provided.

### III. Gripping Structure

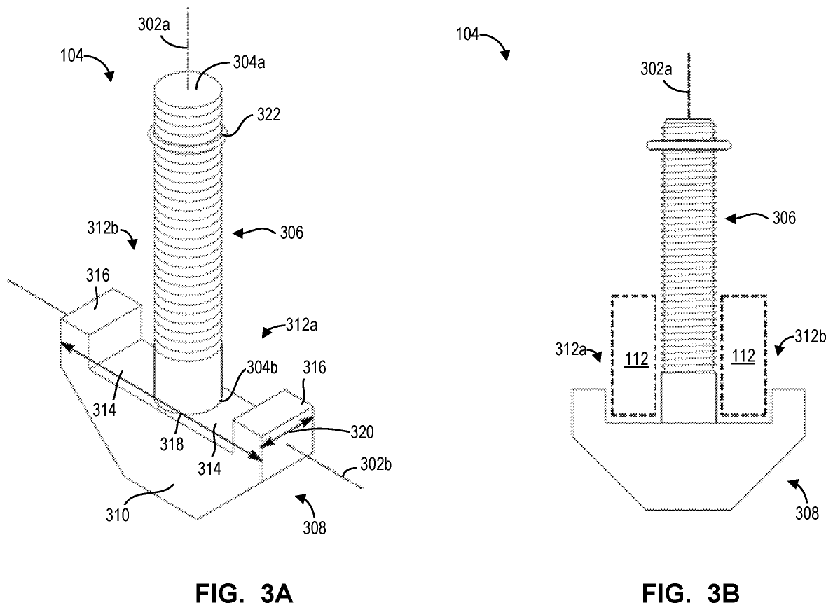

FIGS. 3A-3B exemplify the gripping structure 104 in greater detail, and in accordance with at least one example.

As shown therein, the gripping structure 104 generally extends along an extension axis 302a. The gripping structure 104 further includes: (i) an elongated support stem 306, coupled (e.g., integrally formed) with (ii) a cleat base member 308.

Elongated stem 306 provides a ‘sliding’ support for the securing bracket 106. That is, as shown in FIG. 2B, the securing bracket 106 engages and axially slides over the elongated stem 306. This allows the user to adjust the clamp 102 to accommodate different thicknesses of load bars 112 by raising or lowering the securing bracket 106 relative to the cleat member 308.

As best shown in FIG. 3A, the elongated stem 306 itself extends axially, along axis 302a, between a first “upper” end 304a and a distal second “lower” end 304b. While shown as a linear member, it is not necessary that the stem is perfectly straight.

In some examples, the elongated stem 306 is fully or partially threaded along its axial length. This allows a threaded fastener 202 (e.g., a nut) (FIG. 2B) to engage over the elongate stem 306, and secure the bracket 106 into position.

In other cases, it is not necessary that the elongated stem 306 is threaded. For example, the stem can accommodate a non-threaded fastener 202 which simply slides over the stem until it engages the securing bracket 106 (e.g., a fastener that uses a friction fit over the stem 306, or an interference fit). Alternatively, or in addition, the securing bracket 106 is configured to secure itself into position.

As further exemplified, the elongated stem 306 may include a limiting portion 322 (FIGS. 2B and 3A). Limiting portion 322 may be positioned proximal the first stem end 304a. As shown in FIG. 2B, limiting portion 322 prevents the securing bracket 106—as well as the fastener 202—from sliding off the stem 306. The advantage of this is to ensure that bracket 106, or fastener 202, do not inadvertently dislodge.

Limiting portion 322 can have any desirable configuration. For instance, the limiting portion 322 may be integrally formed with the stem 306, such as a flared-out portion of the stem (e.g., a radial projection). In other examples, the limiting portion 322 is a separate component coupled to the stem 306. For instance, the limiting portion 322 is a retaining ring, sleeve stop, spacer, or another nut or bolt.

Continuing reference to FIG. 3A, the cleat member 308 is coupled (e.g., integrally formed to) the lower stem end 304b. In other cases, the cleat member 308 may be coupled to any other portion of the stem 306.

The purpose of the cleat member 308 is to engage the load bars 112 on the lower grating side 110b (FIG. 1). To enable this function, the cleat member 308 extends along a lateral dimension 318 (FIG. 3A). Lateral dimension 318 may be defined along a lateral axis 302b, substantially orthogonal to the extension axis 302a. In other cases, the lateral axis 302b is at any desired angle to the extension axis 302a.

Along this lateral dimension 318, the cleat member 308 includes one or more load bar engagement portions 312.

As best shown in FIGS. 1 and 3B, each engagement portion 312 engages an underside of one or more load bars 112. The engagement portions 312 accordingly secure the clamp assembly 102 below the grating panel 110 by the interference between the load bars 112 and the engagement portions 312. That is, they prevent the gripping structure 104 from sliding up back through the grating panel 110.

In the illustrated example, the cleat member 308 includes two engagement portions 312a, 312b positioned on either side of the stem 306. Lateral dimension 318 extends such that the engagement portions 312a, 312b span at least the distance of the load bar spacing 116, such as to engage at least two load bars 112 (see e.g., FIG. 3B). By engaging two load bars 112, the clamp 102 is better secured to the grating panel 110. In some cases, however, the same principles apply using only a single engagement portion 312.

As shown in FIG. 3A, each engagement portion 312 can include an engagement surface 314, which abuts the load bars 112. In some cases, the engagement portions 312 have a hook design. For example, a laterally distal part, of each engagement portion 312, includes an axial protrusion 316. As illustrated in FIG. 3B, the hook-like protrusions 316 engage an outer side surface of each load bar 112. This provides an increased securing mechanism between the cleat member 308 and load bars 112 by minimizing lateral slippage between the cleat member 308 and load bars 112.

In some examples, the cleat member 308 is configured with a generally triangular cross-sectional shape (or trapezoidal shape). This may provide additional structural rigidity to the cleat member 308, which is important when the clamp assembly 102 is securing heavy external structures to the grating panel 114. In some cases, the cleat member 308 has a generally polygonal cross-sectional shape, which may include truncated triangular, trapezoidal, or wedge-shaped structures.

### IV. Securing Bracket

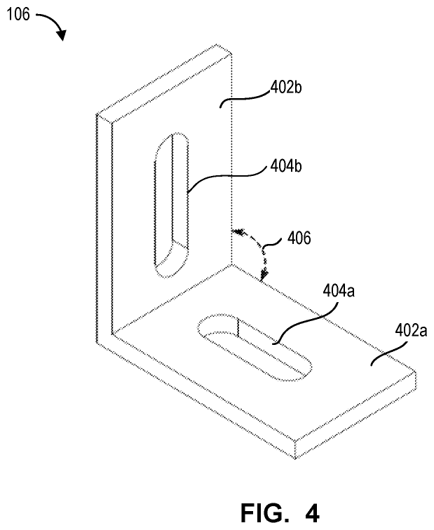

With reference to FIG. 4, clamping assembly 102 also includes the securing bracket 106. The function of the securing bracket 106 is to couple external structures to the grating clamp assembly 102, thereby securing these structures to the grating panel 110.

The securing bracket 106 broadly comprises at least a first flange portion 402a and a second flange portion 402b. It is possible that the securing bracket 106 includes more than two flange portion 402a, 402b.

Each flange portion 402a, 402b includes a corresponding securing slot hole 404a, 404b. As shown in FIGS. 1 and 2, at least one of the slot holes 404a receives the elongate stem 306 of the gripping structure 104. This allows the securing bracket 106 to slide over the elongate stem 306.

The second slot hole 404b can receive a fastener, or the like, to secure an external structure (e.g., a ladder) to the bracket 106. For example, a threaded bolt or screw is inserted through the second slot hole 404b to secure the external structure.

In some cases, one or both of the slot holes 404a, 404b extends in an elongated or longitudinal manner, such as to form an extended hole. By way of example, the slot holes 404a, 404b may have an oblong or ovular shape, as illustrated. The advantage of this design is to provide a degree of freedom in adjusting the relative coupling position of the securing bracket 106 (and thereby, the entire clamp assembly 102) with respect to the secured external structure.

Flanges 404a, 404b may be oriented at any relative separation angle 406 (FIG. 4). For instance, as exemplified, the separation angle 406 may be generally 90° (e.g., ±10°). This separation angle is advantageous because it allows the clamp assembly 102 to secure various structures positioned at a right angle to the grating panel 114, e.g., ladders and other structures.

### V. Method of Installation

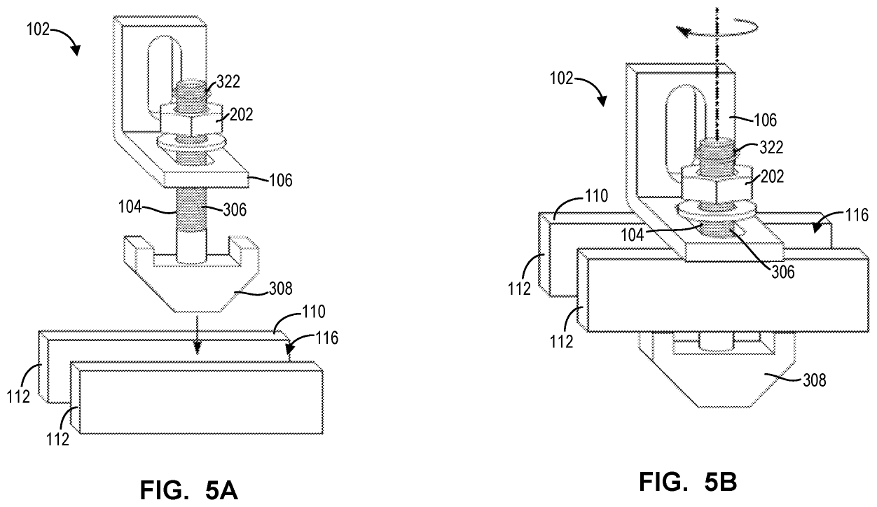

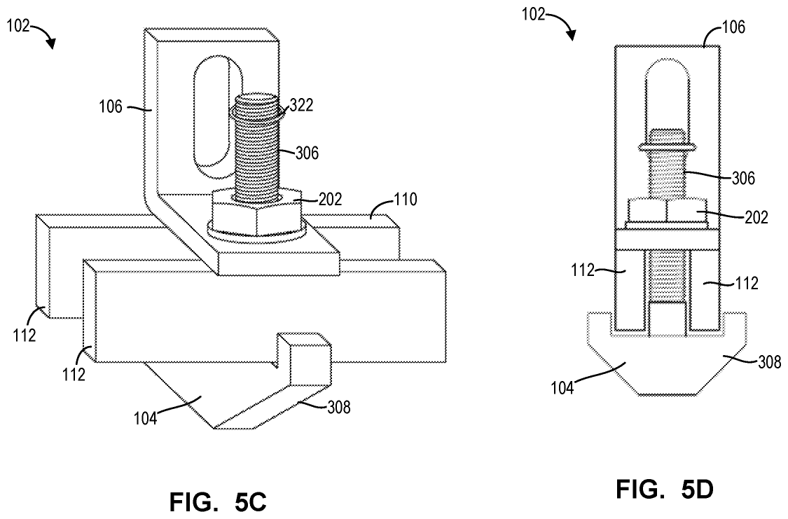

FIGS. 5A-5D exemplify a method for using or installing the grating clamp assembly 102, such that is coupled to a grating panel 110.

### (i) Uninserted State

As shown, in FIG. 5A, the clamp assembly 102 is initially inserted (e.g., passed or positioned) through the grating panel 110. This involves inserting the gripping structure 104 through the load bar spacing 116 until the cleat member 308 is positioned below the gratings 110, i.e., on the other side of the grating panel 110.

Prior to inserting the clamp assembly 102 through the grating panel 110, the clamp assembly 102 is said to be in the “uninserted state” (FIG. 5A). This state is characterized by the clamp assembly 102 being disposed away from the grating panel 110. Further, in this state, the securing bracket 106 is loosely engaged over the elongate stem 306. In other cases, the securing bracket 106 is not coupled to the stem 306.

### (ii) Uncoupled Inserted State

Once the clamp assembly 102 is inserted through the load bar spacing 116 (FIG. 5B), it is said to be in the “uncoupled inserted state”. In this state, the cleat member 308 and the securing bracket 106 are disposed on opposing sides of the grating panel 110. Further, the elongated stem 306 passes through the load bar spacing 116.

To enable the clamp assembly 102 to transition into the uncoupled inserted state—as shown in FIG. 5B, the gripping structure 104 is rotated relative to the load bars 112.

In particular, the gripping structure 104 is rotated such that the lateral dimension 318 of the cleat member 308 is generally parallel to the load bars 112. This allows inserting and passing the cleat member 308 between and through the load bar spacing 116. The rotation of the gripping structure 104 may occur around its extension axis 302a, e.g., via the stem 306. In some examples, the gripping structure 102 is simply rotated such that the cleat member 308 is able to pass through the load bar spacing 116.

It will be appreciated that cleat member 308 is specifically designed such that its thickness dimension 320 (FIG. 3A) is smaller or narrower than the load bar spacing 116. This facilitates the passing through motion shown in FIG. 5B.

### (iii) Inserted Rotated State

Once the clamp assembly 102 is in the uncoupled inserted state (FIG. 5B), the gripping structure 104 is then again rotated (e.g., by a user), around the extension axis 302a.

As exemplified in FIG. 5C, the gripping structure 104 is rotated until the engagement portions 312a, 312b are disposed at least partially under (e.g., at least partially aligned with) one or more separate load bars 112. For example, the gripping structure 104 is rotated until the lateral dimension 318, of the cleat member 308, is substantially perpendicular or orthogonal to the load bars 112. This is also referenced herein as the “inserted rotated state”.

In this state, the cleat member 308 is prevented (or obstructed) from passing back through the load bar spacing 116. This is because the lateral dimension 318 of the cleat member 108 is wider than the load bar spacing 116.

### (iv) Coupled State

Once in the inserted rotated state, the securing bracket 106 is slid down until the flange portion 404a engages the upper side of the load bars 112 (FIGS. 5C and 5D). The fastener 202 is then used to secure the clamp assembly 102 to the grating panel 110. This allows the clamp assembly to be in the “coupled sate”.

In the coupled state, one or more load bars 112 are directly engaged (i) on one side by the engagement portions 312a, 312b of cleat member 308 (FIG. 3A), and (ii) on the other side, by the flange portion 404a of the securing bracket 106 (FIG. 4). This ensures that the clamp assembly 102 is fully secured to the grating panel 110.

In other examples, as discussed previously, it is possible that a fastener 202 is not threaded. For example, the fastener 202 may have a tight fit engagement around the stem 306 such that it can be slid down to secure the bracket 106 from its other side. In other cases, the securing bracket 106 may not requiring any fastener. For example, the securing hole 404a (FIG. 4) may itself have a tight fit engagement around the stem 306 such that it can secure in place in the coupled position.

### (v) Uncoupling the Clamp Assembly

To uncouple the clamp assembly, the same process is repeated in reverse.

### VI. Appreciated Advantages

In view of the above discussion, there are a few appreciated advantages to the disclosed grating clamp assembly 102.

First, the clamp assembly 102 is couplable to the grating panel 110 without necessitating removal of the grating panel, e.g., from a platform. This is because the clamp assembly 102 is entirely coupled “over the top” of the grating panel 110. That is, only one side of the grating panel 110 needs to be accessed to complete the coupling. This results from using the cleat member 308, which is designed to rotate between: (i) the inserted uncoupled state (FIG. 5B) to effectively “unlock” the clamp assembly 102; and (ii) the inserted rotated state (FIGS. 5C-5D) to “lock” the clamp assembly in conjunction with the securing bracket 106. The cleat member 308 therefore secures the clamp assembly 102 from below the grating panel 108, while allowing the user to only manipulate the stem 306 and the top securing bracket 102.

Second, there is no risk of bolts or nuts falling through and below the grating panel 110. This is because the fastener 202 is located above the grating panel 110, and over the securing bracket 106 (rather than below the grating panel 110). Where the limiting member 322 is provided (FIG. 2B), this also prevents the securing bracket 106, fastener 202 or washer 204 from being dislodged.

Third, the securing back 106 is dimensioned such that the flange 404a is wider than the load bar spacing 116. This, in turn, prevents the whole clamp assembly 102 from falling through the grating 110.

Fourth, because the securing bracket 106 is slidable over the elongate stem 306—this allows axially moving the securing member 106 to accommodate different height thickness of the grating panel 110.

Fifth, in some examples, the clamp assembly 102 is provided as a self-assembled and self-contained unit. For example, as shown in FIG. 5A, the securing bracket 106 and fastener 202 are provided such that they are always retained along the elongated stem 306, i.e., as between the limiting portion 322 and cleat member 308. This allows provisioning the clamp assembly 102 as a single self-contained unit, without needing the user to assemble the clamp 102 from disparate parts (which may be lost during the installation process).

### VII. Interpretation

Various systems, apparatuses, or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A grating clamp assembly, comprising:
a gripping structure, comprising an elongated stem and a cleat member; and
a securing bracket, comprising at least two flange members, each flange member having a securing slot hole,
wherein in an assembled state, the securing bracket is movably coupled over the elongated stem through one of the securing slot holes.

2. The assembly of claim 1, wherein the elongated stem further comprises a limiting portion, and in the assembled state, the securing bracket is coupled between the cleat member and the limiting portion.

3. The assembly of claim 2, further comprising a fastener, and in the assembled state, the fastener is coupled to the elongated stem, between the securing bracket and limiting portion.

4. The assembly of claim 1, wherein the cleat member includes one or more load bar engagement portions.

5. The assembly of claim 4, wherein at least one of the engagement portions includes a distal protrusion to form a hook-like design.

6. A method of using the grating clamp assembly of claim 1, comprising:
inserting the gripping structure through a load bar spacing, in a grating panel, until the cleat member is disposed on the other side of the grating panel;
rotating the gripping structure until the engagement portions, of the cleat member, are aligned under one or more load bars; and
engaging the securing bracket over the load bars to couple the clamp assembly.

7. The method of claim 6, initially comprising, rotating the gripping structure such as to allow it to pass through the load bar spacing.

8. The method of claim 6, further comprising, securing the bracket using the fastener.

9. The method of claim 6, further comprising, coupling an external structure to the securing bracket via the other securing hole.

10. The method of claim 9, wherein the external structure is a ladder, railing, or other equipment.
